(19) United States
(12) Patent Application Publication
(10) Pub. No.: US 2007/0220900 A1
(43) Pub. Date: Sep. 27, 2007

(54) Auxiliary gas turbine engine assembly, aircraft component and controller

(75) Inventors: Michael Shockling, Clifton Park, NY (US); Karl Edward Sheldon, Rexford, NY (US)

Correspondence Address: GENERAL ELECTRIC COMPANY, GE AVIATION, ONE NEUMANN WAY MD H17, CINCINNATI, OH, 45215, US

(73) Assignee: General Electric Company

(21) Appl. No.: 11/389,711

(22) Filed: Mar. 27, 2006

(51) Int. Cl. F02C 6/00

(52) U.S. Cl. 60/802

(57) ABSTRACT

A non-aircraft-propelling auxiliary gas turbine engine assembly includes an auxiliary gas turbine engine and a mixing damper. The auxiliary engine and the mixing damper are installable in an aircraft having at least one aircraft-propelling main gas turbine engine. The auxiliary engine includes a compressor having a compressor inlet. The mixing damper has first and second inlets and has an outlet. The outlet is fluidly connectable to the compressor inlet. The first and second inlets are adapted to receive first and second gas streams which have been compressed by at least one main engine. An aircraft component includes a mixing damper. A controller includes a program which instructs the controller to increase/decrease a first gas stream in response to increasing/decreasing electrical demands on an electric generator operatively connected to an auxiliary gas turbine engine of an aircraft.

### BACKGROUND OF THE INVENTION

The present invention relates generally to gas turbine engines, and more particularly to a non-aircraft-propelling auxiliary gas turbine engine assembly, to an aircraft component thereof, and to a controller therefor.

Known auxiliary gas turbine engines are installed in some aircraft to provide mechanical shaft power to electrical and hydraulic equipment such as electrical power generators and alternators and hydraulic pumps. The inlet of the compressor of such auxiliary gas turbine engines receives air from the atmosphere. Because the density of air decreases with increasing altitude, such auxiliary gas turbine engines, at increased altitude, must either work harder to produce a desired shaft power resulting in an increased operating temperature or must reduce the output shaft power to stay within an operating temperature limit.

Still, scientists and engineers continue to seek improved non-aircraft-propelling auxiliary gas turbine engine assemblies, aircraft components thereof, and controllers therefor.

### BRIEF DESCRIPTION OF THE INVENTION

A first expression of a first embodiment of the invention is for a non-aircraft-propelling auxiliary gas turbine engine assembly including a non-aircraft-propelling auxiliary gas turbine engine and a mixing damper. The auxiliary gas turbine engine and the mixing damper are installable in an aircraft having at least one aircraft-propelling main gas turbine engine. The auxiliary gas turbine engine includes an auxiliary-gas-turbine-engine compressor having a compressor inlet. The mixing damper has first and second mixing-damper inlets and has a mixing-damper outlet. The mixing-damper outlet is fluidly connectable to the compressor inlet. The first mixing-damper inlet is adapted to receive a first gas stream which has been compressed by at least one main gas turbine engine. The second mixing-damper inlet is adapted to receive a different second gas stream which has been compressed by at least one main gas turbine engine.

A second expression of a first embodiment of the invention is for an aircraft component including a mixing damper installed in an aircraft having a non-aircraft-propelling auxiliary gas turbine engine and at least one aircraft-propelling main gas turbine engine. The auxiliary gas turbine engine includes an auxiliary-gas-turbine-engine compressor having a compressor inlet. The mixing damper has first and second mixing-damper inlets and has a mixing-damper outlet. The mixing-damper outlet is fluidly connected to the compressor inlet. The first and second mixing-damper inlets each are fluidly-connected to at least one main gas turbine engine to receive respective and different first and second gas streams.

A third expression of a first embodiment of the invention is for a controller installable in an aircraft, wherein the aircraft has a non-aircraft-propelling auxiliary gas turbine engine, an electric generator operatively connected to the auxiliary gas turbine engine to be driven by the auxiliary gas turbine engine, a mixing damper, and at least one aircraft-propelling main gas turbine engine. The auxiliary gas turbine engine includes an auxiliary-gas-turbine-engine compressor having a compressor inlet. The mixing damper has first and second mixing-damper inlets and has a mixing-damper outlet. The mixing-damper outlet is fluidly connected to the compressor inlet. The first mixing-damper inlet is fluidly-connected to at least one main gas turbine engine to receive a first gas stream. The controller includes a program which instructs the controller to increase the first gas stream in response to increasing electrical demands on the electric generator and which instructs the controller to decrease the first gas stream in response to decreasing electrical demands on the electric generator.

### BRIEF DESCRIPTION OF THE DRAWINGS

The accompanying drawings illustrate an embodiment of the invention wherein:

FIG. 1 is a schematic representation of an embodiment of an aircraft having two aircraft-propelling main gas turbine engines, a non-aircraft-propelling auxiliary gas turbine engine, a mixing damper, an electrical generator, and a controller, wherein the mixing damper has first and second mixing-damper inlets adapted to receive a first and a different second gas stream, wherein, in FIG. 1, the example of the first gas stream is bleed air from the pressurized cabin and the example of the second gas stream is bleed air from the compressor of one of the main gas turbine engines; and

FIG. 2 is a schematic representation of examples of various gas streams which can be controlled by the controller and which can be included alone or in combination in the first gas stream and which can be included alone or in combination in the different second gas stream.

### DETAILED DESCRIPTION OF THE INVENTION

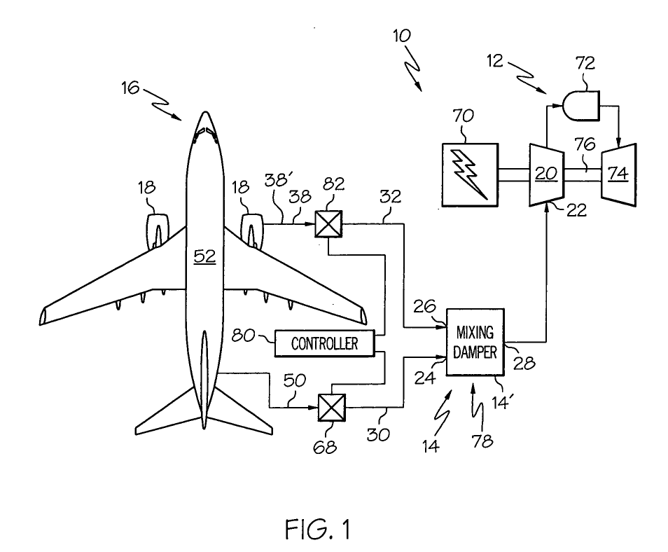

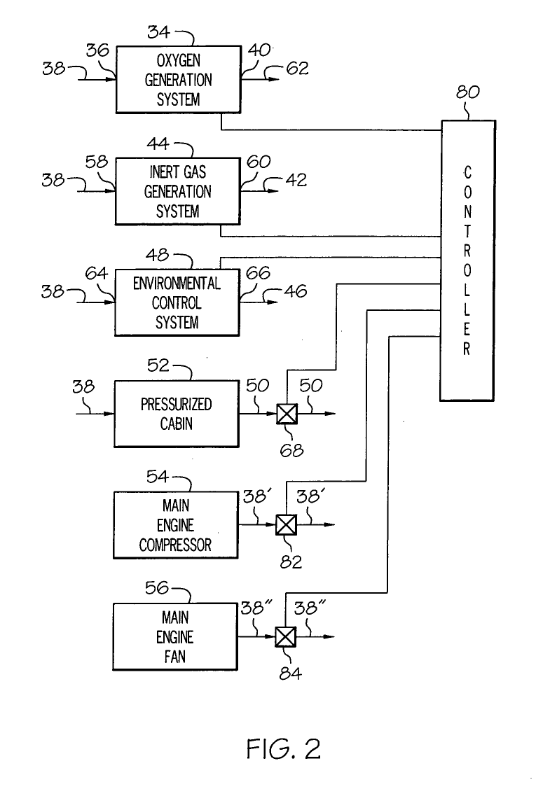

Referring now to the drawings, FIGS. 1-2 disclose a first embodiment of the invention. A first expression of the embodiment of FIGS. 1-2 is for a non-aircraft-propelling auxiliary gas turbine engine assembly 10 comprising a non-aircraft-propelling auxiliary gas turbine engine 12 and a mixing damper 14. The auxiliary gas turbine engine 12 and the mixing damper 14 are installable in an aircraft 16 having at least one aircraft-propelling main gas turbine engine 18. The auxiliary gas turbine engine 12 includes an auxiliary-gas-turbine-engine compressor 20 having a compressor inlet 22. The mixing damper 14 has first and second mixing-damper inlets 24 and 26 and has a mixing-damper outlet 28. The mixing-damper outlet 28 is fluidly connectable to the compressor inlet 22. The first mixing-damper inlet 24 is adapted to receive a first gas stream 30 which has been compressed by at least one main gas turbine engine 18. The second mixing-damper inlet 26 is adapted to receive a different second gas stream 32 which has been compressed by at least one main gas turbine engine 18.

It is noted that each gas stream 30 and 32 may have been directly or indirectly (through intervening aircraft systems) compressed by one or more of the at least one main gas turbine engine 18. In one example, not shown, the mixing damper 14 has at least one additional mixing-damper inlet.

In one enablement of the first expression of the embodiment of FIGS. 1-2, the mixing damper 14 is chosen from the group consisting of a plenum 14′, a turbo expander/compressor, and an ejector. Such examples of mixing dampers are well known to those skilled in the art. For instance, in one deployment of a turbo expander/compressor, not shown, the expander (turbine) of the turbo expander/compressor has an inlet adapted to receive the first gas stream and has an outlet in fluid communication with the compressor inlet of the auxiliary gas turbine engine. The compressor of the turbo expander/compressor is mechanically coupled to the expander, has an inlet adapted to receive the second gas stream, and has an outlet in fluid communication with the compressor inlet of the auxiliary gas turbine engine. The second gas stream is entrained and compressed, wherein the outlets of the expander and the compressor of the turbo expander/compressor have substantially the same pressure and are combined to deliver a greater mass flow to the inlet of the compressor of the auxiliary gas turbine engine, as can be appreciated by those skilled in the art.

In one arrangement of the first expression of the embodiment of FIGS. 1-2, the aircraft 16 includes an onboard oxygen generation system 34 having an inlet 36 in fluid communication with bleed air 38 from at least one main gas turbine engine 18 and having a waste gas outlet 40, wherein the first gas stream 30 is obtained from at least the waste gas outlet 40 of the oxygen generation system 34. It is noted that the bleed air 38 is a gas stream which has been compressed by at least one main gas turbine engine 18. The bleed air 38 is compressed by the compressor of at least one main gas turbine engine 18 and/or by the fan of at least one main gas turbine engine 18 (if the at least one main gas turbine engine 18 is equipped with a fan). In one variation, the second gas stream 32 includes at least one of a waste gas stream 42 of an inert gas generation system 44 onboard the aircraft 16, a waste gas stream 46 of an air-cooling environmental control system 48 onboard the aircraft 16, bleed air 50 from a pressurized cabin 52 of the aircraft 18, bleed air 38′ from a compressor 54 of at least one main gas turbine engine 18, and bleed air 38″ from a fan 56 of at least one main gas turbine engine 18.

In one illustration of the first expression of the embodiment of FIGS. 1-2, the aircraft 16 includes an onboard inert gas generation system 44 having an inlet 58 in fluid communication with bleed air 38 from at least one main gas turbine engine 18 and having a waste gas outlet 60, wherein the first gas stream 30 is obtained from at least the waste gas outlet 60 of the inert gas generation system 44. In one variation, the second gas stream 32 includes at least one of a waste gas stream 62 of an oxygen generation system 34 onboard the aircraft 16, a waste gas stream 46 of an air-cooling environmental control system 48 onboard the aircraft 16, bleed air 50 from a pressurized cabin 52 of the aircraft 16, bleed air 38′ from a compressor 54 of at least one main gas turbine engine 18, and bleed air 38″ from a fan 56 of at least one main gas turbine engine 18. It is noted again that not all main gas turbine engines have fans.

In one application of the first expression of the embodiment of FIGS. 1-2, the aircraft 16 includes an onboard air-cooling environmental control system 48 having an inlet 64 in fluid communication with bleed air 38 from at least one main gas turbine engine 18 and having a waste gas outlet 66, wherein the first gas stream 30 is obtained from at least the waste gas outlet 66 of the air-cooling environmental control system 48. In one variation, the second gas stream 32 includes at least one of a waste gas stream 62 of an oxygen generation system 34 onboard the aircraft 16, a waste gas stream 42 of an inert gas generation system 44 onboard the aircraft 16, bleed air 50 from a pressurized cabin 52 of the aircraft 16, bleed air 38′ from a compressor 54 of at least one main gas turbine engine 18, and bleed air 38″ from a fan 56 of at least one main gas turbine engine 18.

In one deployment of the first expression of the embodiment of FIGS. 1-2, the aircraft 16 includes a pressurized cabin 52, wherein the first gas stream 30 is obtained from at least a bleed-air valve 68 of the pressurized cabin 52. In one variation, the second gas stream 32 includes at least one of a waste gas stream 62 of an oxygen generation system 34 onboard the aircraft 16, a waste gas stream 42 of an inert gas generation system 44 onboard the aircraft 16, a waste gas stream 46 of an air-cooling environmental control system 48 onboard the aircraft 16, bleed air 38′ from a compressor 54 of at least one main gas turbine engine 18, and bleed air 38″ from a fan 56 of at least one main gas turbine engine 18.

In one configuration of the first expression of the embodiment of FIGS. 1-2, the auxiliary gas turbine engine assembly 10 also includes an electric generator 70 installable in the aircraft 16 and operatively connectable to the auxiliary gas turbine engine 12 to be rotated by the auxiliary gas turbine engine 12. In one construction, the compressor 20 of the auxiliary gas turbine engine 12 is a high-pressure compressor supplying compressed air to the combustor 72 of the auxiliary gas turbine engine 12, and the auxiliary gas turbine engine 12 has a turbine 74 mechanically coupled to the compressor 20 by a shaft 76. In one variation, not shown, the auxiliary gas turbine engine 12 includes a low-pressure turbine which rotates an additional electric generator. In one modification, not shown, a venting valve, is interposed between the compressor 20 and the combustor 72. In the same or a different modification, not shown, the first and/or the second gas streams 30 and 32 are heated in a heat exchanger by waste heat from the air-cooling environmental control system 48. It is noted that the flow of gas in FIGS. 1-2 is indicated by arrowed lines, electrical connections are indicated by non-arrowed lines, and mechanical shaft connections are indicated by double non-arrowed lines.

A second expression of the embodiment of FIGS. 1-2 is for an aircraft component 78 comprising a mixing damper 14 installed in an aircraft 16 having a non-aircraft-propelling auxiliary gas turbine engine 12 and at least one aircraft-propelling main gas turbine engine 18. The auxiliary gas turbine engine 12 includes an auxiliary-gas-turbine-engine compressor 20 having a compressor inlet 22. The mixing damper 14 has first and second mixing-damper inlets 24 and 26 and has a mixing-damper outlet 28. The mixing-damper outlet 28 is fluidly connected to the compressor inlet 22. The first and second mixing-damper inlets 24 and 26 each are fluidly-connected to at least one main gas turbine engine 18 to receive respective and different first and second gas streams 30 and 32.

In one enablement of the second expression of the embodiment of FIGS. 1-2, the mixing damper 14 is chosen from the group consisting of a plenum 14′, a turbo expander/compressor, and an ejector. In one variation, the mixing damper 14 mixes the first and second gas streams 30 and 32 at a substantially common static pressure. In the same or a different enablement, the aircraft 16 includes an electric generator 70 operatively connected to the auxiliary gas turbine engine 12 to be driven by the auxiliary gas turbine engine 12.

In one arrangement of the second expression of the embodiment of FIGS. 1-2, the first and second gas streams 30 and 32 each include at least one of a waste gas stream 62 of an oxygen generation system 34 onboard the aircraft 16, a waste gas stream 42 of an inert gas generation system 44 onboard the aircraft 16, a waste gas stream 46 of an air-cooling environmental control system 48 onboard the aircraft 16, bleed air 50 from a pressurized cabin 52 of the aircraft 16, bleed air 38′ from a compressor 54 of at least one main gas turbine engine 18, and bleed air 38″ from a fan 56 of at least one main gas turbine engine 18.

A third expression of the embodiment of FIGS. 1-2 is for a controller 80 installable in an aircraft 16, wherein the aircraft 16 has a non-aircraft-propelling auxiliary gas turbine engine 12, an electric generator 70 operatively connected to the auxiliary gas turbine engine 12 to be driven by the auxiliary gas turbine engine 12, a mixing damper 14, and at least one aircraft-propelling main gas turbine engine 18. The auxiliary gas turbine engine 12 includes an auxiliary-gas-turbine-engine compressor 20 having a compressor inlet 22. The mixing damper 14 has first and second mixing-damper inlets 24 and 26 and has a mixing-damper outlet 28. The mixing-damper outlet 28 is fluidly connected to the compressor inlet 22. The first mixing-damper inlet 24 is fluidly-connected to at least one main gas turbine engine 18 to receive a first gas stream 30. The controller 80 includes a program which instructs the controller 80 to increase the first gas stream 30 in response to increasing electrical demands on the electric generator 70 and which instructs the controller 80 to decrease the first gas stream 30 in response to decreasing electrical demands on the electric generator 70.

In one arrangement of the third expression of the embodiment of FIGS. 1-2, the first gas stream 30 includes at least one of a waste gas stream 62 of an oxygen generation system 34 onboard the aircraft 16, a waste gas stream 42 of an inert gas generation system 44 onboard the aircraft 16, a waste gas stream 46 of an air-cooling environmental control system 48 onboard the aircraft 16, bleed air 50 from a pressurized cabin 52 of the aircraft 16, bleed air 38′ from a compressor 54 of at least one main gas turbine engine 18, and bleed air 38″ from a fan 56 of at least one main gas turbine engine 18.

In one enablement of the third expression of the embodiment of FIGS. 1-2, the controller 80 is operatively connected to a respective at least one of the oxygen generation system 34, the inert gas generation system 44, the environmental control system 48, a bleed air valve 68 of the cabin, a bleed air valve 82 of the compressor 54, and a bleed air valve 84 of the fan 56.

In one deployment of the third expression of the embodiment of FIGS. 1-2, the second mixing-damper inlet 26 is fluidly connected to at least one of a waste gas stream 62 of an oxygen generation system 34 onboard the aircraft 16, a waste gas stream 42 of an inert gas generation system 44 onboard the aircraft 16, a waste gas stream 46 of an air-cooling environmental control system 48 onboard the aircraft 16, bleed air 50 from a pressurized cabin 52 of the aircraft 16, bleed air 38′ from a compressor 54 of at least one main gas turbine engine 18, bleed air 38″ from a fan 56 of at least one main gas turbine engine 38, and the atmosphere.

In one utilization, bleed air and waste gas streams originally compressed by the at least one main gas turbine engine 18 are used alone or in combination for the first and different second gas streams 30 and 32 to provide a greater mass flow of gas to the compressor inlet 22 of the auxiliary gas turbine engine 12 to, in one example, produce more electric power from the electric generator 70 (or more power from a hydraulic or pneumatic pump, not shown, rotated by the auxiliary gas turbine engine).

While the present invention has been illustrated by a description of several expressions of an embodiment, it is not the intention of the applicants to restrict or limit the spirit and scope of the appended claims to such detail. Numerous other variations, changes, and substitutions will occur to those skilled in the art without departing from the scope of the invention.

1. A non-aircraft-propelling auxiliary gas turbine engine assembly comprising a non-: aircraft-propelling auxiliary gas turbine engine and a mixing damper, wherein the auxiliary gas turbine engine and the mixing damper are installable in an aircraft having at least one aircraft-propelling main gas turbine engine, wherein the auxiliary gas turbine engine includes an auxiliary-gas-turbine-engine compressor having a compressor inlet, wherein the mixing damper has first and second mixing-damper inlets and has a mixing-damper outlet, wherein the mixing-damper outlet is fluidly connectable to the compressor inlet, wherein the first mixing-damper inlet is adapted to receive a first gas stream which has been compressed by at least one main gas turbine engine, and wherein the second mixing-damper inlet is adapted to receive a different second gas stream which has been compressed by at least one main gas turbine engine.

2. The auxiliary gas turbine engine assembly of claim 1, wherein the mixing damper is chosen from the group consisting of a plenum, a turbo expander/compressor, and an ejector.

3. The auxiliary gas turbine engine assembly of claim 1, wherein the aircraft includes an onboard oxygen generation system having an inlet in fluid communication with bleed air from at least one main gas turbine engine and having a waste gas outlet, wherein the first gas stream is obtained from at least the waste gas outlet of the onboard oxygen generation system.

4. The auxiliary gas turbine engine assembly of claim 3, wherein the second gas stream includes at least one of a waste gas stream of an inert gas generation system onboard the aircraft, a waste gas stream of an air-cooling environmental control system onboard the aircraft, bleed air from a pressurized cabin of the aircraft, bleed air from a compressor of at least one main gas turbine engine, and bleed air from a fan of at least one main gas turbine engine.

5. The auxiliary gas turbine engine assembly of claim 1, wherein the aircraft includes an onboard inert gas generation system having an inlet in fluid communication with bleed air from at least one main gas turbine engine and having a waste gas outlet, wherein the first gas stream is obtained from at least the waste gas outlet of the on-board inert gas generation system.

6. The auxiliary gas turbine engine assembly of claim 5, wherein the second gas stream includes at least one of a waste gas stream of an oxygen generation system onboard the aircraft, a waste gas stream of an air-cooling environmental control system onboard the aircraft, bleed air from a pressurized cabin of the aircraft, bleed air from a compressor of at least one main gas turbine engine, and bleed air from a fan of at least one main gas turbine engine.

7. The auxiliary gas turbine engine assembly of claim 1, wherein the aircraft includes an onboard air-cooling environmental control system having an inlet in fluid communication with bleed air from at least one main gas turbine engine and having a waste gas outlet, wherein the first gas stream is obtained from at least the waste gas outlet of the onboard air-cooling environmental control system.

8. The auxiliary gas turbine engine assembly of claim 7, wherein the second gas stream includes at least one of a waste gas stream of an oxygen generation system onboard the aircraft, a waste gas stream of an inert gas generation system onboard the aircraft, bleed air from a pressurized cabin of the aircraft, bleed air from a compressor of at least one main gas turbine engine, and bleed air from a fan of at least one main gas turbine engine.

9. The auxiliary gas turbine engine assembly of claim 1, wherein the aircraft includes a pressurized cabin, and wherein the first gas stream is obtained from at least a bleed-air valve of the pressurized cabin.

10. The auxiliary turbine engine assembly of claim 9, wherein the second gas stream includes at least one of a waste gas stream of an oxygen generation system onboard the aircraft, a waste gas stream of an inert gas generation system onboard the aircraft, a waste gas stream of an air-cooling environmental control system onboard the aircraft, bleed air from a compressor of at least one main gas turbine engine, and bleed air from a fan of at least one main gas turbine engine.

11. The auxiliary gas turbine engine assembly of claim 1, also including an electric generator installable in the aircraft and operatively connectable to the auxiliary gas turbine engine to be rotated by the auxiliary gas turbine engine.

12. An aircraft component comprising a mixing damper installed in an aircraft having a non-aircraft-propelling auxiliary gas turbine engine and at least one aircraft-propelling main gas turbine engine, wherein the auxiliary gas turbine engine includes an auxiliary-gas-turbine-engine compressor having a compressor inlet, wherein the mixing damper has first and second mixing-damper inlets and has a mixing-damper outlet, wherein the mixing-damper outlet is fluidly connected to the compressor inlet, and wherein the first and second mixing-damper inlets each are fluidly-connected to at least one main gas turbine engine to receive respective and different first and second gas streams.

13. The aircraft component of claim 12, wherein the mixing damper is chosen from the group consisting of a plenum, a turbo expander/compressor, and an ejector.

14. The aircraft component of claim 12, wherein the mixing damper mixes the first and second gas streams at a substantially common static pressure.

15. The aircraft component of claim 12, wherein the aircraft includes an electric generator operatively connected to the auxiliary gas turbine engine to be driven by the auxiliary gas turbine engine.

16. The aircraft component of claim 12, wherein the first and second gas streams each include at least one of a waste gas stream of an oxygen generation system onboard the aircraft, a waste gas stream of an inert gas generation system onboard the aircraft, a waste gas stream of an air-cooling environmental control system onboard the aircraft, bleed air from a pressurized cabin of the aircraft, bleed air from a compressor of at least one main gas turbine engine, and bleed air from a fan of at least one main gas turbine engine.

17. A controller installable in an aircraft, wherein the aircraft has a non-aircraft-propelling auxiliary gas turbine engine, an electric generator operatively connected to the auxiliary gas turbine engine to be driven by the auxiliary gas turbine engine, a mixing damper, and at least one aircraft-propelling main gas turbine engine, wherein the auxiliary gas turbine engine includes an auxiliary-gas-turbine-engine compressor having a compressor inlet, wherein the mixing damper has first and second mixing-damper inlets and has a mixing-damper outlet, wherein the mixing-damper outlet is fluidly connected to the compressor inlet, wherein the first mixing-damper inlet is fluidly-connected to at least one main gas turbine engine to receive a first gas stream, and wherein the controller includes a program which instructs the controller to increase the first gas stream in response to increasing electrical demands on the electric generator and which instructs the controller to decrease the first gas stream in response to decreasing electrical demands on the electric generator.

18. The controller of claim 17, wherein the first gas stream includes at least one of a waste gas stream of an oxygen generation system onboard the aircraft, a waste gas stream of an inert gas generation system onboard the aircraft, a waste gas stream of an air-cooling environmental control system onboard the aircraft, bleed air from a pressurized cabin of the aircraft, bleed air from a compressor of at least one main gas turbine engine, and bleed air from a fan of at least one main gas turbine engine.

19. The controller of claim 18, wherein the controller is operatively connected to a respective at least one of the oxygen generation system, the inert gas generation system, the environmental control system, a bleed air valve of the cabin, a bleed air valve of the compressor, and a bleed air valve of the fan.

20. The controller of claim 19, wherein the second mixing-damper inlet is fluidly connected to at least one of a waste gas stream of an oxygen generation system onboard the aircraft, a waste gas stream of an inert gas generation system onboard the aircraft, a waste gas stream of an air-cooling environmental control system onboard the aircraft, bleed air from a pressurized cabin of the aircraft, bleed air from a compressor of at least one main gas turbine engine, bleed air from a fan of at least one main gas turbine engine, and the atmosphere.
